(19) United States
(12) Patent Application Publication
(10) Pub. No.: US 2003/0147604 A1
(43) Pub. Date: Aug. 7, 2003

(54) Housing assembly for providing combined electrical grounding and fiber distribution of a fiber optic cable

(76) Inventors: Alejandro L. Tapia, Spartanburg, SC (US); Conley L. McGee, Simpsonsville, SC (US); Kenneth A. Lane, Hendersonville, NC (US)

Correspondence Address: ALCOA INC, ALCOA TECHNICAL CENTER, 100 TECHNICAL DRIVE, ALCOA CENTER, PA, 15069-0001, US

(21) Appl. No.: 10/061,821

(22) Filed: Feb. 1, 2002

(51) Int. Cl. G02B 6/44; G02B 6/00

(52) U.S. Cl. 385/101; 385/135

(57) ABSTRACT

A grounding and transition assembly for providing combined electrical grounding and distributed transition of a bundle of fiber optic strands associated with a fiber optic cable. The assembly includes a three dimensional housing having an assembleable top and bottom and defining a first section proximate an inlet end for seating an inserting end of the fiber optic cable. The assembleable top and bottom further defining a second substantially open interior section communicable with the first section and extending to an open outlet end. A grounding cable has a first end secured to the three dimensional housing, a second end of the grounding cable securing to a remote location from said housing and providing for conducting of electrical charge associated with the fiber optic cable away from the housing. A three dimensional insert sealingly engages within the second interior section and includes a plurality of interiorly defined apertures. A plurality of elongated tubular portions are seatingly engaged within associated apertures in the insert, each of the tubular portions receiving exposed portions of each sub-divided plurality of the bundled fibers and prior to the individual fiber bundles passage through the outlet end.

### FIELD OF THE INVENTION

The present invention relates generally to housing assemblies for use with a fiber optic cable. More particularly, the present invention discloses an assembleable housing for providing electrical grounding of a stainless steel tube jacketed about a fiber optic cable, combined with distribution of individual pluralities of fibers, in environmentally sealing fashion, for subsequent output functions.

### BACKGROUND OF THE INVENTION

Fiber optic technology is known in the aft for accomplishing splicing of such as fiber optical cables and ribbons. The objective of such splicing assemblies and housings, known in the relevant art as “splice trays”, is to subdivide a specified plurality of given optical fibers or strands in some particular fashion for a specified output application.

One example of a splice holder for optical fiber splices is illustrated in U.S. Pat. No. 6,259,851, issued to Daoud, and which teaches provision of a base, at least two opposed rows of retention members which openings for accepting single splices, and lateral member extending in the areas between opposing retention members and for accepting the ribbon splices. The splice holder is formed of unitary construction from a flexible material and can be attached to the splice tray by adhesive, double sided tape, or by the use of tabs on the splice holder which can slide under engagement means on the splice tray.

U.S. Pat. No. 5,835,657, issued to Suarez et al., teaches a fiber optic splice closure assembly having a generally elongate casing with generally parallel sidewalls, first and second end walls and a generally planar base. A number of additional components are provided within the splice tray for assisting in optical fiber dressing and these include lateral pivot assemblies, longitudinal hinge assemblies, alignment bosses, buffer tube receiving channels with buffer tube retainers, splice blocks, tier bracket hinge assemblies and interlocking assemblies to assist in aligning and securing a plurality of such splice trays together and to secure the buffer tubes within the splice tray.

Finally, U.S. Pat. No. 6,201,921, issued to Quesnel et al., teaches a splice enclosure for joining together two or more fiber optic cables. The enclosure is further designed for handling re-entry of possible future splicing of cables not currently active, such as in the addition of more cables or servicing of exiting cables. The enclosure may be mounted by appropriate fasteners and further includes a weather and impact resistant casing and a covered drawer easily removed from the casing and taken to an area wherein splicing can be conducted. The drawer includes a splice tray retaining area, which can accommodate several splice trays at a time. The drawer further includes a buffer tube storage area where stored buffer tubes will not exceed desired bend radii.

### SUMMARY OF THE INVENTION

The present invention discloses an assembleable housing for providing electrical grounding of a stainless steel tube jacketed about a fiber optic cable, combined with distribution of individual pluralities of fibers, in environmentally sealing fashion, for subsequent output functions. The present invention in particular addresses specific shortcomings in the prior art, most notable of which being the lacking in the relevant fiber management technology for providing electrical grounding of a uni-tube fiber optical cable, combined with effective and environmentally sealing distribution of selected sub-counts of fibers (in particular individual divisions of up to 12 fibers apiece subdivided from a 72 count fiber cable) for downstream applications such as individual splice tray assemblies, terminal/plug-in applications, and the like.

A three dimensional housing includes assembleable top and bottom members, typically constructed of a metallic material, and defining a first section proximate an inlet end for seating an inserting end of the fiber optic cable. A second substantially open interior section of the housing communicates with the first interior section and extends to an open outlet end.

A grounding cable includes a first end securing through aligning apertures defined in the top and bottom members of the housing. A second end of the grounding cable typically secures to a remote location from the housing and so that residual electrical charge created by the fiber optic bundle, and its encircling stainless steel tube, is conducted through the housing and across the grounding cable.

A three dimensional insert, typically also constructed from a metallic material, sealingly engages within the second interior section in communicating fashion with the outlet end and includes a plurality of lengthwise extending apertures for receiving associated and individual elongated tubular portions. Each of the tubular portions receives exposed portions of a sub-divided plurality of the fiber bundle (typically again up to 12 such fibers apiece) and prior distributing the sub-divided plurality through the outlet end and to the designated output application. In this fashion, the exposed portion of each subdivided plurality of fibers is protected during handling and storage of the fibers and is further safeguarded from potential environmental damage.

### BRIEF DESCRIPTION OF THE DRAWINGS

FIG. 1 is an operational view, in perspective, of the housing assembly and illustrating the combined electrical grounding of the input cable and management/breakout of individual sub-pluralities of fiber strands of the cable according to the present invention;

FIG. 2 is a cutaway view, taken along line 2-2 of the cable shown in FIG. 1, and further illustrating in cross section the construction of the stainless steel tube and surrounding polyurethane jacket about the plurality of fiber optic strands; and

FIG. 3 is an exploded view of the housing assembly shown in FIG. 1 and illustrating the various components of the assembly, including the top and bottom housing members, grounding cable and mounting fastener, and holder insert for receiving a plurality of individual tubes corresponding to individual breakout sub-pluralities of fiber strands.

### DETAILED DESCRIPTION OF PREFERRED EMBODIMENTS

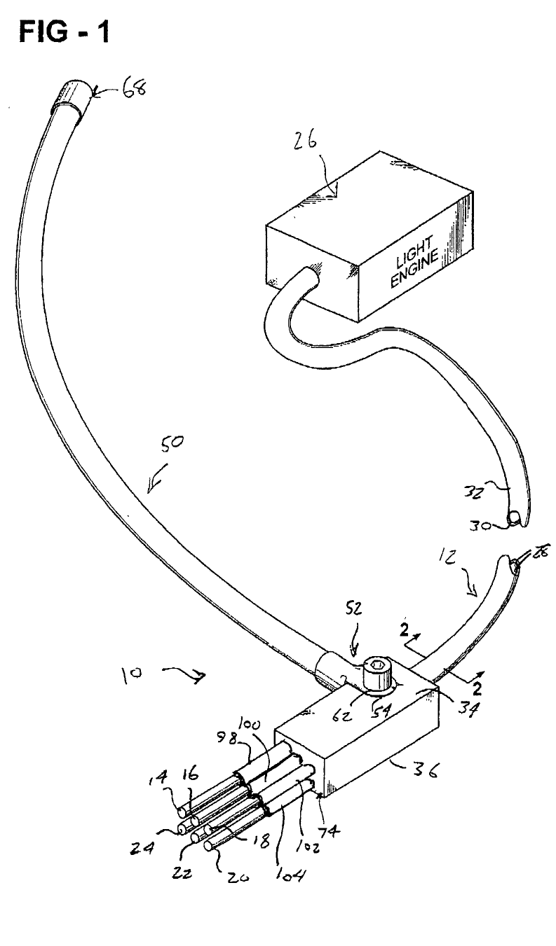

Referring now to FIG. 1, a perspective illustration is shown at 10 of an assembleable housing for providing electrical grounding of a fiber optic cable 12, combined with the ability to distribute individual sub-pluralities of fiber strands, e.g. at 14, 16, 18, 20, 22 and 24, from the cable 12, in both environmentally sealing and structurally secure fashion, for subsequent output functions. As previously stated, the present invention addresses the lacking in the relevant fiber management technology for providing electrical grounding of the fiber optic, combined with the effective and environmentally sealing distribution of selected sub-counts of fibers, in particular individual divisions of up to 12 fibers apiece, such as subdivided from a 72 count fiber cable, and for downstream applications such as the provision of individual splice tray assemblies, terminal/plug-in applications, and the like (not shown). It is also understood that the grounding and transition assembly of the present invention is further suitable for application in fiber management breakout applications of as few as two (2) fibers and again up to a bundled fiber count of seventy-two (72) or more fibers.

It is understood in the art that an appropriate input source creates the necessary energy output for operating the fiber optic cable 12. In the example shown in FIG. 1, the input light source includes by example, and without limitation such, as a light engine 26. Referring further to FIG. 2, a cutaway view of the fiber optic cable 12 is again shown and typically includes the selected number of individual optical fibers (or strands), such as are illustrated at 28. The fiber bundle 28 is typically encased within a tubing 30, such as constructed of a stainless steel or suitable material having the necessary properties of strength, durability/environmental sealability, as well as electrical conductivity. Jacketed about the steel tubing 30 is a polymer based and substantially sealing/non-conducting material such as a polyurethane coating 32. An additional plastic tubing 31 fits inside the tube 30. This plastic tube 31 protects the fibers 28 from the metal edges of the tube 30. The tubing piece 31 does not come with the cable 12, rather it is a piece that is inserted in the metal tube 30 and through which the fibers 28 pass.

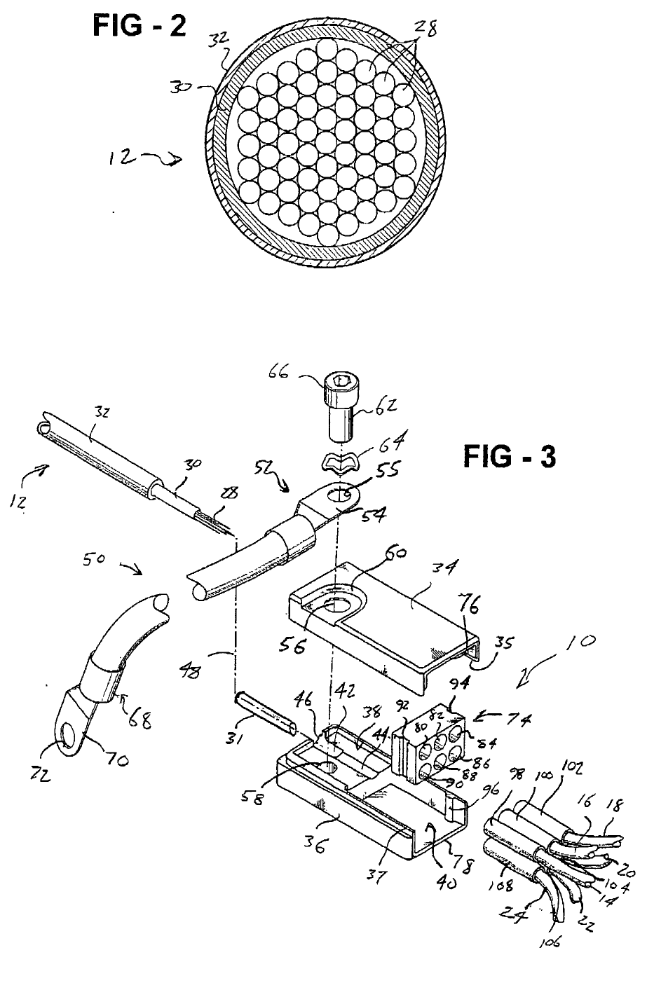

Referring again to FIG. 1, as well as to FIG. 3, the fiber optic cable 12 (such as which may also be commercially referred to as a uni-tube optical cable) extends from its light/power source 26 to the grounding and transition assembly 10 of the present invention. Referring particularly to FIG. 3, the housing is more particularly shown as a three-dimensional enclosure defined by assembleable top 34 and bottom 36 members. The top 34 and bottom 36 members are typically constructed of an electrically conductive and metallic material, and each are in the preferred embodiment substantially elongated in shape having a generally rectangular outer configuration and opposing and mating inner facing configurations, and such as are assembleable by mating and configured surfaces 35 (for top 34) and 37 (for bottom 36) extending around the perimeter of each of the opposingly mating and interiorly open surfaces of both the top and bottom housing members. The open interior of the housing (as best shown from the bottom 36), includes a first fiber optic cable seating section 38 and a second substantially open interior section 40 in communicating arrangement with the first seating section 38. As will be explained in more detail, the sections 38 and 40 of the housing interior provide access to the opposite inlet and outlet ends and for engaging and branching the fiber optic cable into the desired applications.

As illustrated by the revealed portions of the bottom housing member 36, and in particular the first seating section 38, a recessed channel arrangement is shown and includes an enlarged and lengthwise extending slotted portion 42, succeeded by a somewhat narrowed and continuing slotted portion 44, these corresponding to the inserting end of the optic cable 12 and in particular the boundary between a cutoff point of the outer polymer based coating 32 and intermediate stainless steel tube 30 and the extending and exposed bundle 28 of fiber strands. The exposed bundle 28 of fibers are inserted through an inlet end 46 in the general direction of arrow 48 in FIG. 3. A portion of the steel tubing 30 is revealed by cutting away the polymer based coating 32. This unexposed portion of the tubing 30 seats in the slotted portion 44 (this being necessary so that grounding can occur); the polymer base coating 32 seating in slotted portion 42. The exposed and extending bundle of fiber strands 28 project from the end of the steel tube 30 within the open interior section 40 (here is where the fibers 28 fan out to the insert 74). As will also be better explained with reference to the furthering disclosure, none of the fiber strands associated with the bundle 28 are severed, at any location within the housing 10, and prior to being distributed into the individual sub-pluralities of bundles shown at 14, 16, 18, 20, 22, and 24.

A grounding cable 50 is illustrated (in full length in FIG. 1 and reduced length in FIG. 2). The cable 50 is constructed of a suitable electrically conductive material, such as again a suitable metal filament and typically including an exterior and insulating (such as polymer) based coating material. A first end of the grounding cable 50 is generally referenced at 52 and, referring specifically to FIG. 3, further includes a terminal portion with a substantially flat plate 54 and within which is defined an aperture 55. The assembleable top and bottom housing members 34 and 36 each further includes aligning apertures, see at 56 and 58 respectively for members 34 and 36. Upon mating the housing members 34 and 36 together, and seating the terminal/plate 54 of the grounding cable 50 within such as a seating recess 60 defined within the exterior facing surface of the top member 34, a mounting fastener 62 (such as an appropriate screw or bolt) is secured through the aligning apertures 55 (grounding cable 50), 56 (top assembled housing member 34) and 58 (bottom assembled housing member 36).

It is further understood that some or all of the extending depth of the inner annular surfaces surrounding the apertures 56 and 58 defined within the housing 10, and in particular the depth of the inwardly facing annular walls associated with the aperture 58 in the bottom assembleable member 36, may further include annular threads placed thereon and which engage with associated threads defined along an exterior surface of the mounting fastener 62. It is also understood that other types of fastening means, such as nuts and the like, may also be employed and further shown in FIG. 3 is a wave washer 64 which, when installed upon the shaft portion of the fastener 62 and beneath an enlarged head portion 66 of the fastener 62 prevents loosening of the fastener 62 after being tightened to clamp the assembleable housing members 34 and 36 together. A second and remote extending end 68 of the grounding cable 50 likewise may include, see in particular FIG. 3, a suitable terminal portion 70 defining an interior aperture 72 and for engagement (not shown) to a location remote from the housing 10.

Referring once again to the exploded view of FIG. 3, a three dimensional insert 74 is illustrated for sealing and seating engagement within the second substantially open interior section 40 defined within the housing 10. The second open interior section 74 is located proximate and communicable with an outlet end of the housing, this in turn being created by an open-end wall configuration further defined by planar extending edges 76 and 78, respectively in the assembleable top 34 and bottom 36 members.

The insert 74, as with the assembleable top 34 and bottom 36 halves of the housing, is in the preferred embodiment constructed of a metallic and electrically conductive material and further includes a plurality of apertures extending therethrough. It is also contemplated that the insert 74 can be constructed of any other suitable material, such as plastic, ceramic, wood or the like. Specifically, a plurality of six individual apertures (typically circular in cross section) 80, 82, 84, 86, 88, and 90 are illustrated and extend through the insert between a first end communicable with the seating section 38 of the fiber optic cable 12 and extending through to locations proximate and communicable with the outlet end of the housing.

To further assist in locating and sealing/seating engagement of the insert 74, it is further envisioned that recesses, such as at 92 and 94 on opposite extending sides of the insert 74, interengage with opposing and matingly configured projections (see for example at 96 in FIG. 3) defined within the second open interior section 40 of the housing and in particular at specified locations along the assembleable bottom 36. It is also understood that other types of seating and securing structure could be employed for engaging the insert 74 within the open outlet end of the housing and, in the preferred application, it is desired that an end face of the insert 74 align with the corresponding edges of the housing at the second outlet end and such as is illustrated in the assembled view of FIG. 1.

With final reference again to FIG. 3, a plurality of six interiorly hollowed portions, typically tubular elements are provided at 98, 100, 102, 104, 106 and 108. Seating within the open interiors defined in each tubular element is an associated and sub-divided plurality of bundled fibers, such as again previously referenced at 14, 16, 18, 20, 22 and 24 and which are illustrated in correspondingly inserted fashion through tubes 98, 100, 102, 104, 106 and 108 in FIG. 3. The tubes 98-108 in turn are insertingly engaged, typically in biasing or friction fitting fashion, within associated apertures 80-90, however it is also understood that adhesives or other securing means may be employed for engaging the tubes within the associated apertures defined in the insert 74.

As discussed previously, the provision of the insert 74 and sub-dividing/distributing tubes 98-108 provides for dedicated sub-dividing of each sub-plurality of fibers (again at 14-24), from the overall exposed bundle 28 of fibers extending from the cable 12. In the preferred application, a fiber optic cable with a strand count of seventy-two fibers will result in each distributing tubular portion receiving a sub-divided count of up to twelve fibers. Upon complete installation of the housing, the material characteristics of the assembleable top 34 and bottom 36, combined with that of the insert 74, facilitate the optic flow through the dedicated fiber bundles, while at the same time effectively grounding the electric current through the stainless steel (30) part of the cable 12 through the housing and to the grounding cable 50. This electricity can be created by the cable coming in contact with an electric element other than the cable, static electricity or lighting.

The individual sub-pluralities 14-24 of fiber strands are furthermore distributed in extending fashion beyond the outlet end of the housing and to individual output applications, such again previously described as including splice tray assemblies, plug-in attachments (not shown) and the like. It is further envisioned that the extending sub-pluralities 14-24 of strands (the portions of which extend beyond the housing 10) may each also be coated with any suitable covering material (not shown) to provide the necessary sealing and insulating characteristics and prior to their respective and subsequent output applications.

As also previously explained, the electrical grounding and fiber distribution/transition housing of the present invention provides an effective and single unit for both electrically grounding the fiber cable and providing effective fiber management at the breakout point of the sub-divided fiber optic strands. Having described our invention, additional preferred embodiments will become apparent to those skilled in the art to which it pertains and without deviating from the scope of the appended claims.

Having described the presently preferred embodiments, it is to be understood that the invention may be otherwise embodied within the scope of the appended claims.

What is claimed is:

1. A grounding and transition assembly for providing electrical grounding for a fiber optic cable, combined with environmentally sealed and dedicated distribution of individual and sub-divided pluralities of fibers of the cable, said assembly comprising:
a three dimensional housing having an inlet end through which is received the fiber optic cable;
a grounding cable having a first end secured to said three dimensional housing, a second end of said grounding cable securing to a remote location from said housing; and
a plurality of elongated and interiorly hollowed portions located within said housing and proximate an outlet end thereof, each of said interiorly hollowed portions receiving exposed portions of the sub-divided pluralities of fibers prior to said outlet end.

2. The assembly as described in claim 1, said housing further comprising an assembleable top and bottom which, in combination, define a first section proximate said inlet end for seating the fiber optic cable, a second substantially open interior section communicating with said first section and extending to said outlet end.

3. The assembly as described in claim 2, further comprising a three dimensional insert sealingly engaged within said second interior section of said housing, said insert further including a plurality of apertures formed therethrough for receiving each of said elongated and interiorly hollowed portions.

4. The assembly as described in claim 3, said housing having a specified shape and size and further comprising said assembleable top and bottom and said insert each being constructed of a material to facilitate conducting of electrical charge from the fiber optic cable to said grounding cable.

5. The assembly as described in claim 2, further comprising aligning apertures defined in said first end of said grounding cable and each of said assembleable top and bottom of said housing, a fastener engaging through each of said apertures.

6. The assembly as described in claim 1, the fiber optic cable further including a collective bundle of fibers, a stainless steel tubing surrounding said fiber bundle, and a polyurethane coating encasing said steel tubing.

7. The assembly as described in claim 1, said plurality of elongated and interiorly hollowed portions further comprising tubular portions, each of which are capable of receiving a plurality of up to twelve sub-divided fibers.

8. A grounding and transition assembly for providing electrical grounding for a fiber optic cable, combined with environmentally sealed and dedicated distribution of individual and sub-divided pluralities of fibers of the cable, said assembly comprising:
a three dimensional housing having an assembleable top and bottom which, in combination, define a first section proximate an inlet end for seating an inserting end of the fiber optic cable, said assembleable top and bottom further defining a second substantially open interior section communicating with said first section and extending to an outlet end of said housing;
a grounding cable having a first end secured to said three dimensional housing, a second end of said grounding cable securing to a remote location from said housing; and
a plurality of elongated and interiorly hollowed portions seatingly engaged within said second open interior section of said housing, each of said interiorly hollowed portions receiving exposed portions of the sub-divided pluralities of fibers and prior to passage through said outlet end.

9. A grounding and transition assembly for providing electrical grounding for a fiber optic cable, combined with environmentally sealed and dedicated distribution of individual and sub-divided pluralities of an overall bundled plurality of fibers associated with the cable, said assembly comprising:
a three dimensional housing having an assembleable top and bottom defining a first section proximate an inlet end for seating an inserting end of the fiber optic cable, said assembleable top and bottom further defining a second substantially open interior section communicating with said first section and extending to an outlet end of said housing;
a grounding cable having a first end secured to said three dimensional housing, a second end of said grounding cable securing to a remote location from said housing;
a three dimensional insert sealingly engaging within said second interior section and including a plurality of apertures; and
a plurality of elongated tubular portions seatingly engaged within associated apertures in said insert, each of said tubular portions receiving exposed portions of the sub-divided pluralities of fibers and prior to passage through said outlet end.
